(19) United States
(12) Patent Application Publication
(10) Pub. No.: US 2019/0114110 A1
(43) Pub. Date: Apr. 18, 2019

(54) DATA PROCESSING DEVICE

(71) Applicant: FUJI XEROX CO.,LTD., Tokyo (JP)

(72) Inventors: Masatomo IGARASHI, Kanagawa (JP); Masahiro ISHIWATA, Kanagawa (JP); Tsutomu NAGAOKA, Kanagawa (JP); Yoshinori AWATA, Kanagawa (JP)

(73) Assignee: FUJI XEROX CO.,LTD., Tokyo (JP)

(21) Appl. No.: 15/990,694

(22) Filed: May 28, 2018

(30) Foreign Application Priority Data
Oct. 16, 2017 (JP) 2017-200039

(51) Int. Cl. G06F 3/06

(52) U.S. Cl. CPC G06F 3/0659; G06F 3/0673; G06F 3/0604

(57) ABSTRACT

A data processing device includes a software processing section that performs software processing on data, a hardware processing section that performs hardware processing on data, and a memory that stores data transmitted and received between the software processing section and the hardware processing section and sequentially outputs the stored data to the hardware processing section.

### CROSS-REFERENCE TO RELATED APPLICATIONS

This application is based on and claims priority under 35 USC 119 from Japanese Patent Application No. 2017-200039 filed Oct. 16, 2017.

### BACKGROUND

### (i) Technical Field

The present invention relates to a data processing device.

### (ii) Related Art

A technology of performing data processing in which software processing and hardware processing are mixed has been known in the related art.

### SUMMARY

According to an aspect of the invention, there is provided a data processing device which includes a software processing section that performs software processing on data, a hardware processing section that performs hardware processing on data, and a memory that stores data transmitted and received between the software processing section and the hardware processing section and sequentially outputs the stored data to the hardware processing section.

### BRIEF DESCRIPTION OF THE DRAWINGS

Exemplary embodiment(s) of the present invention will be described in detail based on the following figures, wherein:

FIG. 1 is a diagram illustrating a specific example of a data processing device according to an exemplary embodiment of the present invention;

FIG. 2 is a diagram illustrating a specific example of data processing performed by the data processing device in FIG. 1;

FIG. 3 is a flowchart illustrating the specific example of the data processing illustrated in FIG. 2; and

FIG. 4 is a diagram illustrating a specific example of a time required for the data processing.

### DETAILED DESCRIPTION

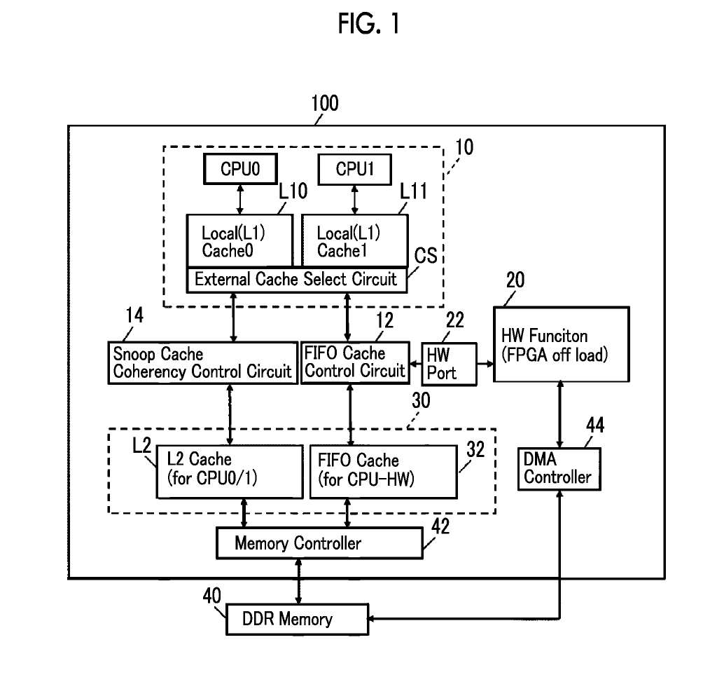

FIG. 1 is a diagram illustrating a specific example of a data processing device 100 according to an exemplary embodiment of the present invention. The data processing device 100 in FIG. 1 includes a software processing unit 10, a hardware processing unit 20, and a data storage unit 30 and further includes other components illustrated in FIG. 1.

The software processing unit 10 performs software processing on data as a processing target. In the specific example illustrated in FIG. 1, the software processing unit 10 includes two CPUs (CPU0 and CPU1), a local cache L10 functioning as a primary cache of the CPU0, a local cache L11 functioning as a primary cache of the CPU1, and an external cache select circuit CS. That is, the software processing unit 10 in the specific example illustrated in FIG. 1 has a multiprocessor configuration. The software processing unit 10 may be realized by a configuration different from that of a multiprocessor.

The hardware processing unit 20 performs hardware processing on data as the processing target. In the specific example illustrated in FIG. 1, the hardware processing unit 20 is realized by a field programmable gate array (FPGA). The hardware processing unit 20 may be realized by using other devices different from the FPGA. For example, the hardware processing unit 20 may be realized by using a dynamic reconfigurable processor (DRP) or a programmable logic device (PLD) or may be realized by an application specific integrated circuit (ASIC) or the like. The hardware processing unit 20 may be realized by using hardware other than the above-described devices.

The data storage unit 30 stores data as a processing target of data processing (software processing and hardware processing). In the specific example illustrated in FIG. 1, the data storage unit 30 includes a cache memory L2 and a FIFO memory 32.

The cache memory L2 functions as a secondary cache of the two CPUs (CPU0 and CPU1). The software processing unit 10 uses the cache memory L2 as a secondary cache, via a snoop cache coherency control circuit 14.

The fast-in-fast-out (FIFO) memory 32 stores data transmitted and received between the software processing unit 10 and the hardware processing unit 20. In the specific example illustrated in FIG. 1, the software processing unit 10 transmits and receives data to and from the FIFO memory 32 via a FIFO cache control circuit 12 and the hardware processing unit 20 transmits and receives data to and from the FIFO memory 32 via the hardware port 22 and the FIFO cache control circuit 12.

The FIFO memory 32 is a storage device capable of reading and writing data at a relatively high speed in a first-in-first-out manner. The FIFO memory 32 is a specific example of a storage device which does not require setting of address information (storage address information) in a case where data is read and written. Storing data transmitted and received between the software processing unit 10 and the hardware processing unit 20 may be realized by using a storage device different from the FIFO memory 32.

In the specific example illustrated in FIG. 1, for example, a double data rate (DDR) memory 40 functions as an external memory of the data processing device 100. The data processing device 100 in FIG. 1 performs data processing on data obtained from the DDR memory 40 via a DMA controller 44 and outputs the processed data to the DDR memory 40 via the DMA controller. The data processing device 100 may realize transmission and reception of data to and from the DDR memory 40 via a memory controller 42.

In a case where the data processing device 100 in FIG. 1 is embodied (for example, commercialized), at least some of the components of the data processing device 100 illustrated in FIG. 1 may be packaged on an integrated circuit (IC), aboard, or the like. For example, at least some of the components of the data processing device 100 in FIG. 1 may be integrated into one IC or more or may be integrated into one board or more.

The overall configuration of the data processing device 100 in FIG. 1 is as follows. Next, a specific example of data processing realized by the data processing device 100 in FIG. 1 will be described. The reference signs in FIG. 1 are used for the components (units having reference signs appended thereto) illustrated in FIG. 1, in the following descriptions.

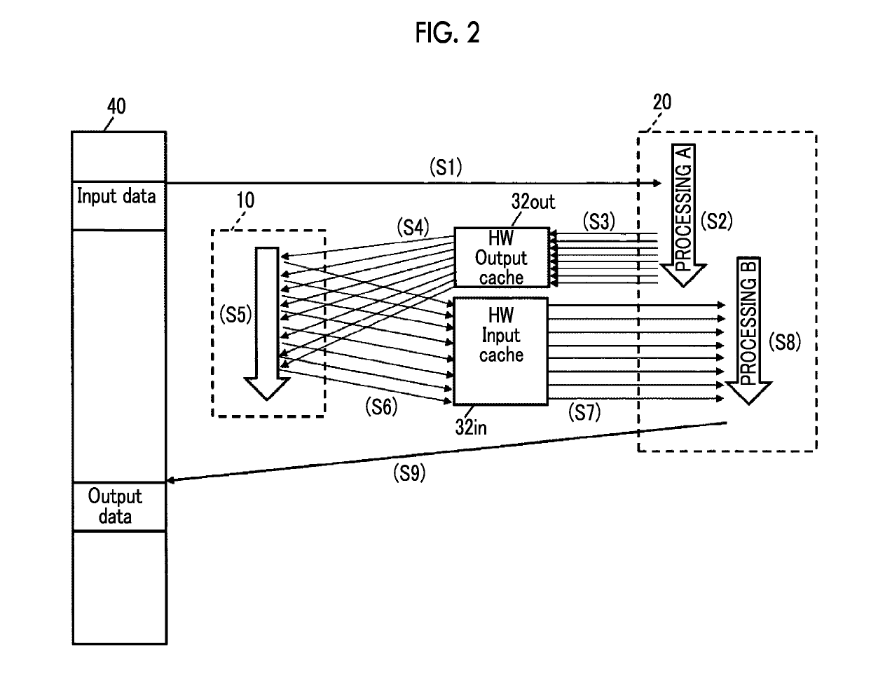

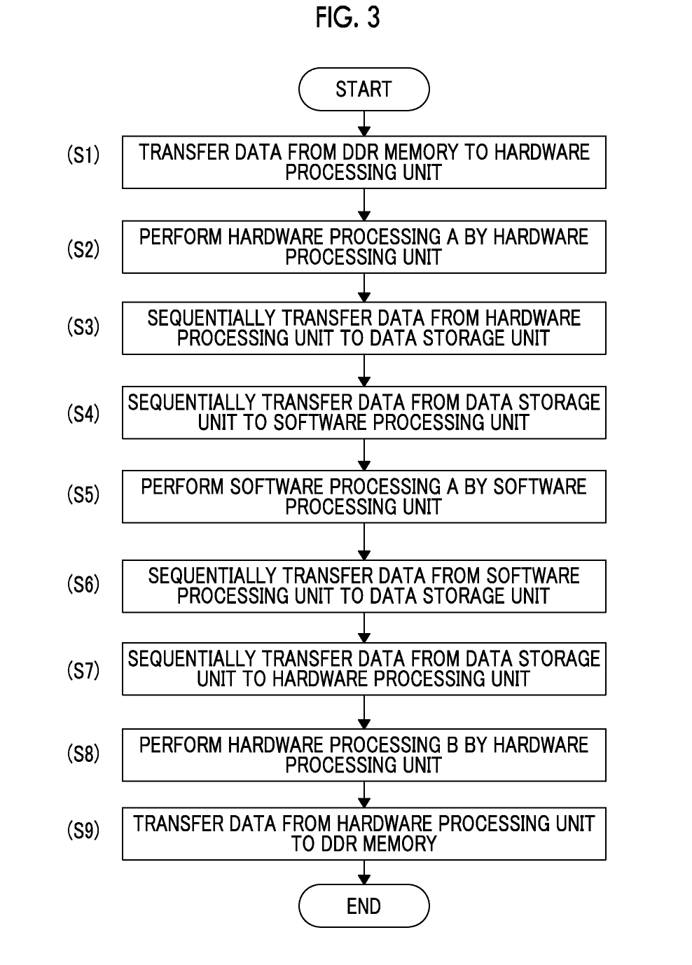

FIG. 2 is a diagram illustrating the specific example of data processing performed by the data processing device 100 in FIG. 1. FIG. 3 is a flowchart illustrating the specific example of the data processing illustrated in FIG. 2. The specific example of the data processing performed by the data processing device 100 in FIG. 1 will be described with reference to FIGS. 2 and 3.

Firstly, data is transferred to the hardware processing unit 20 from the DDR memory 40 (S1). Data used as the processing target by the data processing device 100 is stored in the DDR memory 40. For example, data stored in the DDR memory 40 is transferred to the hardware processing unit 20 by control of the DMA controller 44, in a manner of direct memory access (DMA).

In a case where data as the processing target is transferred, the hardware processing unit 20 performs hardware processing A on the data as the processing target (S2). For example, in a case where data as the processing target, which is obtained from the DDR memory 40 is compressed data (data subjected to compression processing), decompression processing as the hardware processing A is performed on the compressed data. Hardware processing other than the decompression processing may be performed as the hardware processing A.

Data is sequentially transferred from the hardware processing unit 20 to the data storage unit 30 (S3). For example, data subjected to the hardware processing A by the hardware processing unit 20 is transferred one by one to the data storage unit 30 in order of being processed and is stored one by one in the FIFO memory 32 of the data storage unit 30. In the specific example illustrated in FIG. 2, the FIFO memory 32 includes a hardware output cache 32out, and data which is sequentially transferred from the hardware processing unit 20 is stored one by one in the hardware output cache 32out.

Data is sequentially transferred from the data storage unit 30 to the software processing unit 10 (S4). For example, data stored in the data storage unit 30 is transferred one by one to the software processing unit 10 in order of being stored. In the specific example illustrated in FIG. 2, data is transferred one by one from the hardware output cache 32out of the FIFO memory 32 to the software processing unit 10.

In the steps of S3 and S4, the FIFO memory 32 stores data obtained from the hardware processing unit 20, one by one in order of being subjected to the hardware processing A and outputs the stored data to the software processing unit 10 one by one in order of being stored.

In a case where data as the processing target is transferred, the software processing unit 10 performs software processing on the data as the processing target (S5). For example, in a case where data as the processing target is image data, image processing such as color conversion processing is performed as the software processing. Software processing other than the image processing may be performed as the software processing.

Data is sequentially transferred from the software processing unit 10 to the data storage unit 30 (S6). For example, data subjected to software processing by the software processing unit 10 is transferred to the data storage unit 30 one by one in order of being processed and is stored in the FIFO memory 32 of the data storage unit 30 one by one. In the specific example illustrated in FIG. 2, the FIFO memory 32 includes a hardware input cache 32in. Data which is sequentially transferred from the software processing unit 10 is stored one by one in the hardware input cache 32in.

Further, data is sequentially transferred from the data storage unit 30 to the hardware processing unit 20 (S7). For example, data stored in the data storage unit 30 is transferred one by one to the hardware processing unit 20 in order of being stored. In the specific example illustrated in FIG. 2, data is transferred from the hardware input cache 32in of the FIFO memory 32 to the hardware processing unit 20 one by one.

In the steps of S6 and S7, the FIFO memory 32 stores data obtained from the software processing unit 10, one by one in order of being subjected to the software processing and outputs the stored data to the hardware processing unit 20 one by one in order of being stored.

The FIFO memory 32 does not require setting of address information (storage address information) in a case where data is read and written. Thus, in the step of S6, the FIFO memory 32 stores data obtained from the software processing unit 10 without receiving address information for storing data, from the software processing unit 10. In addition, in the step of S7, the FIFO memory 32 outputs the stored data to the hardware processing unit 20 without receiving address information for reading data, from the hardware processing unit 20. Accordingly, reading and writing of data are performed at a relatively high speed in a first-in-first-out manner.

In a case where data subjected to the software processing is transferred, the hardware processing unit 20 performs hardware processing B on the data subjected to the software processing (S8). For example, in the step of S2, in a case where decompression processing is performed as the hardware processing A, compression processing is performed as the hardware processing B. Hardware processing other than the compression processing may be performed as the hardware processing B.

For example, in a case where performing the hardware processing A has been already ended before the hardware processing unit performs the hardware processing B, the hardware processing unit 20 may perform the hardware processing B by changing a processing circuit of the hardware processing A to a processing circuit of the hardware processing B. The hardware processing unit 20 may include two processing circuits of the hardware processing A and the hardware processing B and the two processing circuits may be selectively used.

Data subjected to the data processing is transferred from the hardware processing unit 20 to the DDR memory 40 (S9). For example, data subjected to the hardware processing B by the hardware processing unit 20 is transferred from the hardware processing unit 20 to the DDR memory 40 and stored in the DDR memory 40, by control of the DMA controller 44.

In the specific example illustrated in FIG. 1, the FIFO memory 32 is not normally in an active state. For example, in a case where the software processing unit 10 is not capable of sequentially outputting data as the processing target, the FIFO memory 32 may be in an inactive state. Regardless of enabling the FIFO memory 32, for example, in a case where the FIFO memory is in the inactive state, data may be transmitted and received between the software processing unit 10 and the hardware processing unit 20 via the DDR memory 40.

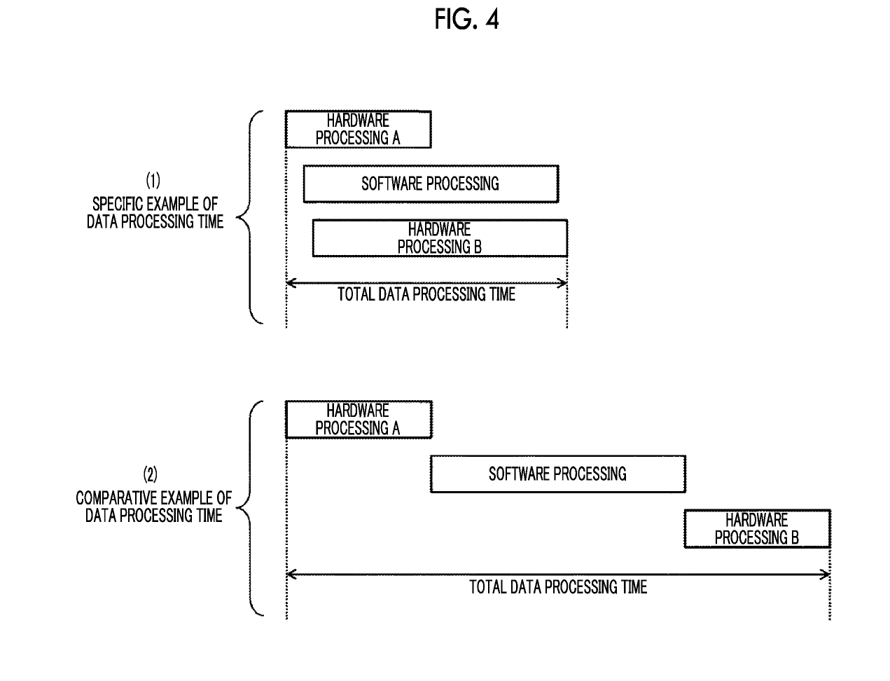

FIG. 4 is a diagram illustrating a specific example of a time required for the data processing. The part (1) of FIG. 4 illustrates a specific example of a data processing time in a case where the data processing device 100 in FIG. 1 performs data processing in FIGS. 2 and 3. In the specific example of the data processing, which is described with reference to FIGS. 2 and 3, for example, data subjected to the hardware processing A is subjected to the software processing one by one in order of being processed and data subjected to the software processing is subjected to the hardware processing B one by one in order of being processed.

On the contrary, the part (2) of FIG. 4 illustrates a comparative example in a case where the same processing (hardware processing A, software processing, and hardware processing B) is performed on the same data as that in the part (1) of FIG. 4. In the comparative example in the part (2) of FIG. 4, the software processing is performed after the hardware processing A is ended, and then the hardware processing B is performed after the software processing is ended.

For example, a comparative example has a configuration obtained by excluding the FIFO memory 32 from the specific example of the data processing device 100 illustrated in FIG. 1. In the comparative example, in a case where data is transmitted and received between the software processing unit 10 and the hardware processing unit 20 via the DDR memory 40 and the data processing (hardware processing A, software processing, and hardware processing B) is performed, a result illustrated in the part (2) of FIG. 4 is obtained.

The data processing device 100 in the specific example illustrated in FIG. 1 includes the FIFO memory 32 and thus data is sequentially transmitted and received between the software processing unit 10 and the hardware processing unit 20 via the FIFO memory 32. Thus, pipeline processing of concurrently performing the hardware processing A, the software processing, and the hardware processing B is realized. Therefore, in the specific example in the part (1) of FIG. 4, the total data processing time (total processing time of hardware processing A, software processing, and hardware processing B) is largely reduced in comparison to the comparative example illustrated in the part (2) of FIG. 4.

In the hardware processing, it is known that the pipeline processing of sequentially performing data processing has high efficiency. Therefore, it is necessary that data is also sequentially input. It is necessary that data input to the hardware processing unit 20 is subjected to processing in the software processing unit 10 and then is written in the DDR memory 40. This is because the data written in the DDR memory 40 may be sequentially read by the hardware processing unit 20. In a case where data is transmitted and received between the software processing unit 10 and the hardware processing unit 20 without passing through the FIFO memory 32, a mechanism of monitoring whether or not the software processing unit 10 ends writing of data in a storage area in which the hardware processing unit 20 reads data is provided. Alternatively, as illustrated in the part (2) of FIG. 4, after all resultant obtained by ending the software processing are written in the DDR memory 40, the hardware processing unit 20 sequentially reads data.

In the specific example illustrated in the part (1) of FIG. 4, the processing time for the hardware processing B is longer than that in the comparative example in the part (2) of FIG. 4. The reason is as follows. In the specific example illustrated in the part (1) of FIG. 4, the hardware processing B is sequentially performed while the software processing is performed. Thus, the processing time for the hardware processing B is influenced by the software processing. However, in the specific example illustrated in the part (1) of FIG. 4, the hardware processing B is performed in parallel with the software processing and the hardware processing B is ended just after the software processing is ended. Thus, the total data processing time is largely reduced in comparison to that in the comparative example illustrated in the part (2) of FIG. 4.

Hitherto, although the exemplary embodiment of the present invention is described, the above-described exemplary embodiment is merely illustrative in all aspects and does not limit the scope of the present invention. The present invention includes various modifications in a range without departing from the gist thereof.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A data processing device comprising:
a software processing section that performs software processing on data;
a hardware processing section that performs hardware processing on data; and
a memory that stores data transmitted and received between the software processing section and the hardware processing section and sequentially outputs the stored data to the hardware processing section.

2. The data processing device according to claim 1,
wherein the memory stores data obtained from the software processing section without receiving storage address information for storing data, from the software processing section.

3. The data processing device according to claim 1,
wherein the memory outputs the stored data to the hardware processing section without receiving storage address information for reading data, from the hardware processing section.

4. The data processing device according to claim 1,
wherein the memory stores data obtained from the software processing section one by one in order of being subjected to software processing and outputs the stored data to the hardware processing section one by one in order of being stored.

5. The data processing device according to claim 2,
wherein the memory stores data obtained from the software processing section one by one in order of being subjected to software processing and outputs the stored data to the hardware processing section one by one in order of being stored.

6. The data processing device according to claim 3,
wherein the memory stores data obtained from the software processing section one by one in order of being subjected to software processing and outputs the stored data to the hardware processing section one by one in order of being stored.

7. The data processing device according to claim 1,
wherein the memory stores data obtained from the hardware processing section one by one in order of being subjected to hardware processing and outputs the stored data to the software processing section one by one in order of being stored.

8. The data processing device according to claim 2,
wherein the memory stores data obtained from the hardware processing section one by one in order of being subjected to hardware processing and outputs the stored data to the software processing section one by one in order of being stored.

9. The data processing device according to claim 3,
wherein the memory stores data obtained from the hardware processing section one by one in order of being subjected to hardware processing and outputs the stored data to the software processing section one by one in order of being stored.

10. The data processing device according to claim 4,
wherein the memory stores data obtained from the hardware processing section one by one in order of being subjected to hardware processing and outputs the stored data to the software processing section one by one in order of being stored.

11. The data processing device according to claim 5,
wherein the memory stores data obtained from the hardware processing section one by one in order of being subjected to hardware processing and outputs the stored data to the software processing section one by one in order of being stored.

12. The data processing device according to claim 6,
wherein the memory stores data obtained from the hardware processing section one by one in order of being subjected to hardware processing and outputs the stored data to the software processing section one by one in order of being stored.

13. The data processing device according to claim 1, further comprising:
a controller that activates the memory,
wherein, in a case where the memory is not activated by the controller, the hardware processing section transmits and receives data to and from the software processing section via an external memory different from the memory.
